(19) United States
(12) Patent Application Publication
(10) Pub. No.: US 2002/0144343 A1
(43) Pub. Date: Oct. 10, 2002

(54) Portable patient turning and lifting device

(76) Inventors: Hendrik Klaas Kuiper, Edwards, MS (US); Danny Earl Ellis, Utica, MS (US)

Correspondence Address: KIRKPATRICK & LOCKHART LLP, 75 STATE STREET, BOSTON, MA, 02109-1808, US

(21) Appl. No.: 09/733,361

(22) Filed: Dec. 8, 2000

(51) Int. Cl. A61G 7/10

(52) U.S. Cl. 5/81.1 R

(57) ABSTRACT

The present invention provides a portable patient turning and lifting device and associated methods for turning and lifting an immobilized patient. The device comprises at least one inflation bladder configured to be secured between the patient's body and the patient supporting surface, such as a bed. The bladder is inflated with pressurized fluid. Preferably, the inflation bladder is secured by a specialized garment that is worn by the immobilized patient. An embodiment configured to be worn about the torso comprises a vest with two inflation bladders oriented on the left and right sides of the back of the garment. Preferably, at least one fluid pump is provided in communication with the bladders, and it is preferably fitted with a controller to tailor the sequencing and timing of the inflation to reposition the patient's body.

### FIELD OF THE INVENTION

The present invention pertains to devices and methods for the prevention and treatment of wounds of patient immobility.

### BACKGROUND OF THE INVENTION

Prevention of wounds associated with immobility and promoting of healing of existing wounds on an immobilized or bedridden patient can be a resource consuming challenge for healthcare providers. Undesirable pathological side effects can result from a patient's bedridden condition which health care providers must attempt to avoid during the patient's immobilization. Of primary concern are pressure ulcers, or bedsores, which result from extended contact between pressure points along the patient's body and the supporting surface, such as a bed mattress. The weight of the patient on these contact areas serves to compress the tissue in these areas. The areas of compressed tissue experience reduced blood circulation. The lack of oxygenated blood can lead to death of cells in the compressed region of tissue. A pressure ulcer may first appear as an area of non-blanch able erythematic and may progress to a deep crater wound that can involve muscle, bone and joints. These wounds typically develop over a bony prominence due to the interface with the patient supporting surface. Left untreated, pressure ulcers can lead to sepsis, which can cause death.

Pressure ulcers can be caused not only by pressure forces against tissue, but also by forces of shear, friction, or maceration applied to the tissue of patient, alone or in combination. These other forces may be generated anytime force is applied to the patient or bed tending to move them relative to each other while contact between the patient and surface, tending to hold the tissue, remains.

Also, if the patient has injuries on or adjacent to the contact areas of tissue, the reduced blood circulation at those pressure points can interfere with the proper healing of those injuries. In short, any medical condition that immobilizes a patient, temporary or chronic, can ultimately lead to the localized circulation problems described above. Any condition that decreases a patient's ability to make positional changes can cause the patient to be easily susceptible to the wounds of immobility.

To alleviate the potential for formation of pressure ulcers or wounds on an immobilized patient, it has been common practice to periodically move the position of the patient's body (typically in bed) so that the pressure of the patient's weight is relieved from the current tissue pressure points and shifted to new pressure points so that blood flow can resume in the formerly pressurized areas. A complication of moving the patient to a new position in the bed is that the immobilized patient cannot exert him or herself to help move their own body. Therefore, the healthcare provider must frequently move the entire patients weight of the patient alone, which can be a difficult task that presents the risk of exertion related injuries to the health care worker. Also, movement of the patient relative to the bed without fully lifting the body from the bed can leave tissue areas under high shear and frictional forces, which cause pressure ulcers. In a large healthcare facility with multiple immobilized patients, manually moving the position of the bedridden patients can consume a significant portion of the healthcare staff's time. Additionally, a patient may have additional injuries or complications requiring special positioning such that certain areas of the body do not experience the pressure of the patient's weight. It may be difficult to manually move the patient's body to the ideal position for proper healing and patient comfort.

Various mechanisms are available for assisting healthcare providers and alleviating the effects of sustained active pressure points on an immobilized patient's body. Patient turning beds provide a patient supporting surface that is capable of rotating about a longitudinal axis of the bed from side-to-side, out of the horizontal plane. The rotation serves to shift the patient's body weight from one side to another in an effort to help reduce the effects of localized tissue pressure points on the patient's body where it meets the supporting surface of the bed. U.S. Pat. No. 5,103,511 (Sequin) discloses such an oscillatory bed.

There are several shortcomings in the use of the turning bed. The patient must be secured in the oscillatory bed so that he or she does not roll out of the bed when it is rotated to a plane that defines an angle away from the horizontal. The bed does not serve to change the position of the patient's body within the bed but only serves to relieve pressure forces on the half of the patient's body above the horizontal plane. With the patient's body still in contact with the supporting surface shear and frictional forces are still exerted on the patient's tissue and may be increased as the patient's body tends to slide across the inclined surface of the turned bed. Additionally, the areas of the body that can be relieved of pressure are limited only to a portion, which lies above the horizontal plane when the bed is rotated.

Another disadvantage of the turning bed is that it requires a substantial expense in equipment and that an entire specialized bed must be obtained (rented, leased, purchased etc.). A patient must be in a facility that has such a bed and must be moved into the specialized bed in order to use it, which can be difficult for the immobilized patient and time consuming for the staff. Furthermore, because the entire bed is not easily moved, accommodations for immobilized patients are limited to where such beds can be located. In instances of patient care to be given in the patient's home, a large mechanical turning bed may not be able to fit in a small sized home.

Another type of specialized bed intended to minimize pressure ulcers is marketed under the name Clinitron®. This type of bed utilizes a base tub of sand with a protective containment covering on top. Air is blown from the bottom upward through the sand to cause the sand to flow and create a fluid-like supporting surface. The patient lies on the protective top covering supported by the bed of fluidized sand. Although the Clinitron approach may tend to equalize the compressive forces across all points of the patient's body, because body contact is maintained with the supporting surface, shear and frictional forces can still exist, which can lead to pressure ulcers.

U.S. Pat. No. 5,774,947 (Liu) discloses a turning mattress formed from inflatable bladders, each having a right and left cell separated by a central diaphragm. The left and right sides of the bladders can be alternately inflated to rotate the patient's body away from the horizontal plane to unweigh that portion of the patient's body which lies above the horizontal plane in the manner of the turning mattress described above. Because the turning mattress is used on a hospital bed, the portability issues raised above in connection with the above-described turning bed still exist. Also, as mentioned above, the turning mattress serves to move the patient only by rotation about a single longitudinal axis and does not serve to lift the patient away from the support surface. Therefore, bony prominences susceptible to pressure ulcers, remain in contact with the supporting surface and forces are translated to the tissue.

U.S. Pat. No. 4,986,260 (lams et al.) and U.S. Pat. No. 6,014,784 (Taylor et al.) disclose pads having multiple inflatable bladders controlled to provide a continuously movable surface upon which an immobilized patient's body can rest. The movement of the inflatable bladder surfaces addresses the problem of continuous pressure at tissue pressure points on the body. An additional problem with devices using multiple bladders is that the patient's body can slip between the bladders diminishing the intended effectiveness of the device and potentially creating discomfort for the patient. Also, the disclosed devices do not operate to turn and reposition the patient's body.

### SUMMARY OF THE INVENTION

The present invention provides a portable patient turning and lifting device that turns and lifts a bedridden patient from a patient supporting surface such as a bed to relieve pressure on critical tissue areas susceptible to pressure ulcers. Because the patient is turned by lifting, contact with the patient supporting surface is discontinued, avoiding the deleterious effects of shear, friction and maceration forces that may be generated on the tissue if contact were not discontinued. The device is fully portable, easy to use by a caregiver, and requires no specialized equipment to operate.

In a preferred embodiment, the invention is defined by a garment configured to be worn about at least a portion of the body of the patient that is immobilized and in need of repositioning. One or more inflation bladders are removably attached to the garment such that they are maintained effectively positioned between the patient and a patient supporting surface, such as a bed. In a preferred embodiment, the garment is configured as a vest that can be easily donned about the torso of an immobilized patient. The garment worn about the torso has a front and back and left and right sides. Preferably, at least left and right inflation bladders are secured to the back of the garment. Because the patient turning and lifting garment is secured to the patient's body, shear forces that would normally be transmitted to a patient's tissue during lifting and turning, are instead, translated to the garment. Because the garment is secured to the patient with little relative motion between the garment and patient body permitted, shear and frictional forces are avoided to more effectively avoid pressure ulcer development.

The inflation bladders are flexible, expandable and individually inflatable with any convenient fluid, such as air, to move the corresponding portion of the patient's body away from the patient supporting surface. The inflatable bladders are joined to a fluid pump system by fluid pressure lines. The pump system includes at least one fluid pump and a pump controller wired to the fluid pump. The pump controller has user controls to provide a variety of inflation conditions, times and sequences. The bladders may be releasably secured to the garment by placement in specially fitted pockets on the exterior surface of the garment so that the bladders can be easily removed for replacement or for cleaning of the garment.

In the preferred embodiment of a vest fitted to be worn about the torso, inflation bladders are arranged, on left and right sides of the back of the garment. In an exemplary operation of the device, the left and right inflation bladders are alternately inflated and deflated at a selected time interval to lift the patient's body so that no given area of tissue remains compressed, under the weight of the body, for an extended period of time, which could result in reduced blood flow to that area. However, the inflation bladders can be inflated in a variety of sequences to position the patient's body in a specific arrangement for a specific period of time, including rapid inflation of all the bladders to facilitate administration of patient care such as bathing or toileting. The garment and bladders may be made from a durable, but flexible material that is reusable or may be made from lightweight, inexpensive materials to be disposable.

The garment may take a variety of forms, with the vest described above merely representing a preferred example. The garment may have sufficient length to cover the torso region to accommodate inflatable bladders that can reorient the torso region of the patient. Alternatively, the garment may comprise sleeves for elevating the arms or may comprise pants to accommodate inflation bladders to elevate the legs, or help to turn the lower region of the body, below the torso. A leg garments may be provided to help to elevate the calves or feet. The number of inflation bladders used in the system, of course, may be varied to provide sufficient coverage for movement of any region of the body desired. Combinations of the different garments listed above may be worn and inflated together or in different sequences to achieve a wide range of patient body movement options.

In an alternate embodiment, the patient turning and lifting device may comprise one or more inflation bladders that are secured to the patient supporting surface. Like the garment embodiment described above, the support surface mounted turning and lifting device utilizes a pump system to inflate the bladders with any convenient fluid, such as air. In the pump system, at least one fluid pump is controlled by a controller, analog or electronic, to regulate the inflation times and sequences of the bladders. The bladders are provided with securement means on their exterior surfaces, such as tie strings, snaps or hook and loop fasteners, so that they may be secured to a support surface fitted with corresponding securement means. The support surface may also be provided with pockets to retain the bladders. When the patient lies on the support surface, the inflation bladders can be inflated to reorient the patient's body at a desired interval and in the configuration desired by the healthcare provider.

It is an object of the present invention to provide a patient turning and lifting device that is portable, reusable, and economical to purchase and maintain.

It is another object of the invention to provide a patient turning and lifting device that is easily installed to reorient the position of a patient without requiring a specialized patient supporting surface to accommodate the turning and lifting device.

It is another object of the invention to provide a patient turning and lifting device embodied in a garment that can be easily donned by the patient, if able, or placed on the patient by a caregiver, and that is configured to releasably secure one or more inflation bladders to the patient's body such that inflation of the bladders results in repositioning of the patient's body relative to a patient supporting surface.

It is yet another object of the invention to provide a method of reorienting the position of a patient's body that involves donning a patient turning garment with inflation bladders and inflating the bladders to move the patient's body relative to a patient supporting surface.

It is yet another object of the invention to provide a patient turning and lifting device that comprises at least one inflation bladder and a mechanism for securing the bladder between the patient's body and a patient supporting surface.

It is yet another object of the invention to provide a patient turning and lifting device that is secured to a patient's supporting surface and that can be inflated to move at least a portion of a patient's body away from the patient's supporting surface.

It is yet another object of the invention to provide a method of reorienting a patient's body on a patient supporting surface that involves securing an inflation bladder to a supporting surface and inflating the bladder to reorient at least a portion of the patient's body being supported by the surface.

It is another objective of the invention to provide an apparatus and method for lifting an immobilized patient from a support surface to avoid the occurrence of pressure wounds and move the patient for purposes of care giving such as bathing, toileting or rendering perineal care.

### BRIEF DESCRIPTION OF THE DRAWINGS

The foregoing and other objects and advantages of the invention will be appreciated more fully from the following further description thereof, with reference to the accompanying diagrammatic drawings wherein:

FIG. 1 is an illustration of a patient wearing a garment-type patient turning and lifting device of the present invention;

FIG. 2 is a front view illustration of a patient wearing a garment-type patient turning and lifting device of the present invention;

FIG. 3 is a rear view illustration of a patient wearing a garment-type patient turning and lifting device of the present invention;

FIG. 4 is an illustration in an isometric view of left and right independent inflation bladders;

FIG. 5 is an illustration of an isometric view of a bladder pack insert with soft inflation bladders shown in phantom;

FIG. 5A is a detailed illustration of a baffle;

FIG. 6 is an illustration of a bladder pack insert identifying dimensional variables;

FIG. 7 shows a schematic of the pump system components.

### DESCRIPTION OF THE ILLUSTRATIVE EMBODIMENTS

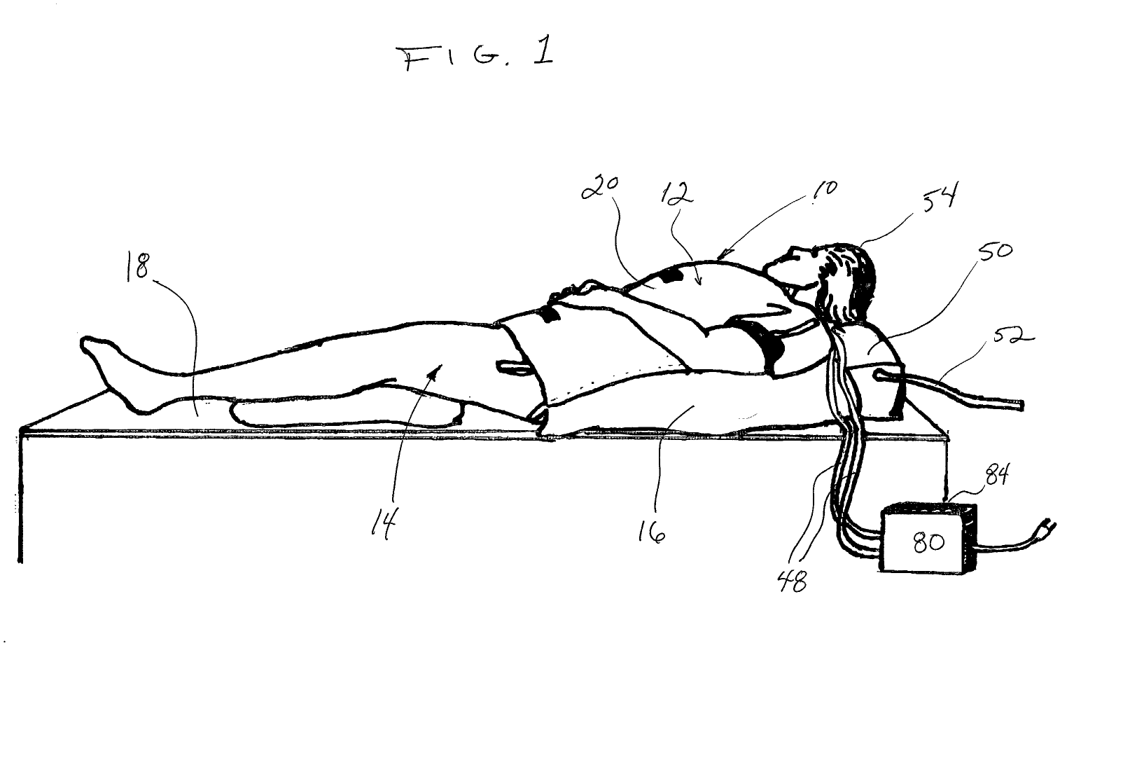

FIG. 1 is an illustration of a patient using an embodiment of the patient turning and lifting device of the present invention. In a preferred embodiment, the patient turning and lifting device 10 comprises a garment 12 that is worn about at least a portion of a patient's body 14 and is configured to hold at least one inflatable bladder 16 securely between the body and patient supporting surface 18 (shown in FIG. 1). The bladders are filled by fluid that is pressurized, preferably by a pump system 80 comprising at least one pump that is in fluid connection with the bladders via fluid lines 48. The pump system is preferably provided with a controller unit to modulate its operation. In combination with a solenoid valve, the pump and controller can be set to fill and empty the bladders in a variety of sequences and time intervals.

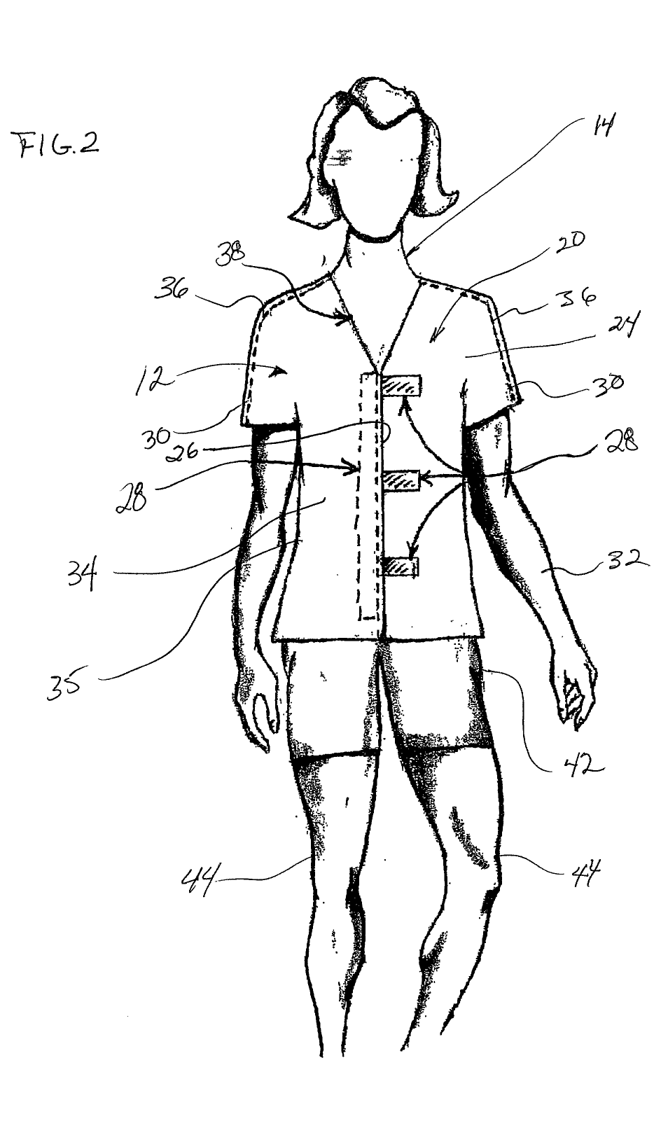

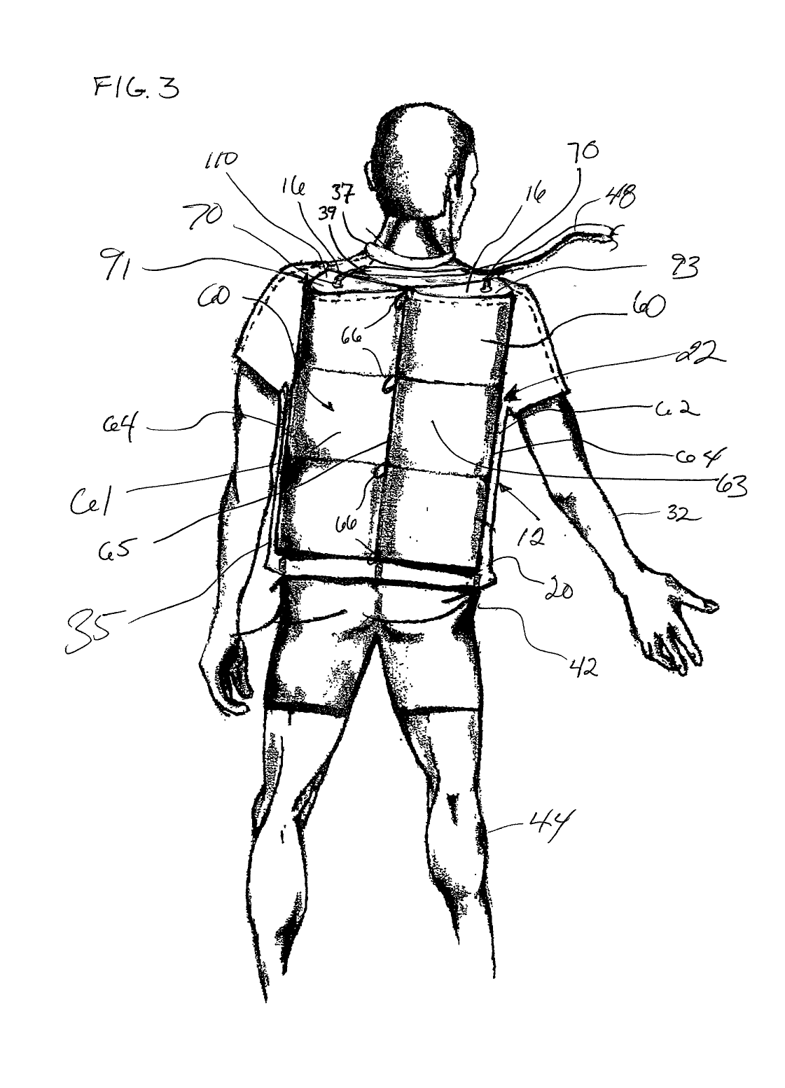

FIGS. 2 and 3 illustrate front and back (respectively) portions of the garment type patient turning and lifting device 12. Although the patient turning and lifting device of the present invention may be configured in various ways, it is important that the inflation bladders 16 be maintained in a position between the body 14 of the patient and a patient supporting surface 18. In this description it is to be understood that a patient supporting surface is typically a bed utilizing a mattress, but may also include any other patient supporting surface such as an examination table, floor, or supporting surfaces of a chair or wheelchair. As the inflation bladders are inflated, their volume will expand to, not only turn the body of the patient, but also lift the body and reorient it relative to the support surface 18.

An advantage of the present invention is its portability and ease of use by a healthcare provider in applying it to a patient regardless of the type of bed the patient is using. FIGS. 1, 2 and 3 show a garment type of turning and lifting device 12 configured as a vest 20. Configuring the portable patient turning and lifting device as a garment to be worn about the patient's body solves the problem of conveniently securing the means for turning the patient, in relative position between the patient 14 and supporting surface 18.

The vest 20, shown in FIGS. 1-3 is believed to provide the best garment configuration for turning and lifting an immobilized patient's torso region. This configuration is discussed as the preferred embodiment because it is recognized, in most instances, an immobilized patient lies on his or her back in a bed. As shown in FIGS. 1-3, the vest 20 can be securely worn about a patient's torso while providing mounting locations along a back portion 22 of the vest where inflation bladders 16 can be secured to lift the patient's body. Because the garment is secured to the patient's body, there is a reduced probability of relative movement between the garment and body during use reducing the generation of shear or frictional forces on the tissue.

Additionally, the vest is configured to have an opening in its front portion 24 to facilitate donning by the patient or placement on the patient's body by a caregiver, if the patient is unable to don the garment without assistance. Fasteners 28 are positioned along the opening to secure the vest about the patient after donning. The fasteners are preferably of the type that is quickly and easily secured by a healthcare professional standing above the patient. Straps of hook and loop type fasteners (such as those available under the trade name Velcro®) can be sewn on to the vest adjacent to the opening 26 in a position that, when secured, will provide a snug fit for the intended size of patient. Alternatively, straps secured by tying, buckles or snaps can be applied to the vest. Regardless of securement mechanism, the vest and placement of the straps can be sewn to fit a wide range of patients.

In a preferred embodiment of the vest garment described above, an inflatable 25 pillow 50 is provided and releasably securable to the top of the vest as is shown in FIG. 1. A pillow fastened to the lifting and turning garment is useful to maintain support for a patient's head 54 regardless of how the device ultimately moves and repositions the patient's body. Without a pillow secured to the vest and maintained in relative orientation under the patient's head, there is a risk that the patient's position could be reoriented away from a standard, unsecured pillow, and leave the head unsupported during lifting of the patient's torso, which could cause discomfort for the patient. The pillow 50 may be attachable to the top of the vest by any quickly releasable means such as tie strings, snaps or hook and loop fasteners. The pillow is preferably inflated separately from the inflation bladders of the turning and lifting garment and does not need to be connected to the fluid circuit created by the pump system 80 and bladders 16. Rather, the pillow 50 may be inflated once, by manual pump joined to a pillow inflation line 52. Alternatively, the pillow need not be an inflatable type, but may simply be a standard pillow that is attachable to the vest and capable of supporting the patient's head when the bladders are fully inflated to elevate the patient's body from the patient supporting surface.

Other preferred features of the vest 20 include sleeves 30 to help anchor the vest by the arms 32 of the patient so that the vest does not move or rotate relative to the torso and become twisted about the torso 34 during use. The sleeves may have a separable seam 36 releasably securable by convenient means such as hook and loop fasteners to facilitate placement of the vest onto an immobilized patient's torso by eliminating the need to place the patients arms through the sleeves. The separable seam also provides access to the patient's arms by healthcare providers to change intravenous connections to the patient. Additionally, the vest is preferably provided with a collarless v-neck front opening 38 to, not only increase the comfort level for the patient, but also to provide access to the patient's chest area for providing patient care. The back of the neck opening may employ a soft collar pad 37 to prevent chafing of the patient's neck. A tubing tract 39 for guiding inflation tubing 48 to the inflatable bladders may also be attached near the collar pad and may comprise a partial fabric sleeve or series of fabric loops. The tract enables the tubing to be passed to either side of the bed, maintaining proper arrangement of the tubing, so that it doesn't become entangled with the patient's body, which may lead to discomfort. Because the tubing is maintained in proper orientation by the tract, placement of the pump that inflates the vest to be located on either side of the bed for convenience to the electrical outlet that will power the pump.

A preferred material for the vest is a soft blend that is easily maintained by standard laundering techniques and that is comfortable and durable. An example of such a material is a blend of 65% cotton and 35% polyester; however, it is recognized that many other types of materials would be suitable for carrying out the invention. The stitching of the garment may also be a blend of 65% cotton and 35% polyester. The inside of the garment may be lined with a separate piece of material to create a seamless inner shell. Alternatively, the garment can be made from a durable paper or other inexpensive material to provide the option of making the garment disposable.

The shape of the vest 20 allows for a snug fit that is tapered through the waist area 35 with hook and loop fastener adjustment straps 28 in the front to provide a secure fit with minimal relative movement between the garment and the patient's body to reduce shear and frictional forces. The overall length of the vest is longer than a standard vest to allow for adequate offloading of the sacrum. The extra length allows the bladders 16 to extend well onto the buttocks and pelvic region 42, insuring adequate offloading of this area. The vest may be manufactured in several standard sizes to fit differently sized patients. In addition to standard sizes, it can also be custom designed and altered through standard tailoring techniques for people of a physical stature that falls outside the standard size ranges.

In the vest embodiment, the posterior side or back side 22 is designed to hold the inflation bladders 16, as best shown in FIG. 3. A preferred system for securing the bladders includes, separate pockets 60 stitched to the outer shell 62 that are sized to closely accept the bladders. Preferably, for the vest embodiment, left and right pockets, 61 and 63 respectively are provided to contain left and right bladders 91 and 93 that are independently inflatable. A center stitched seam 65 may be provided down the center of the posterior side of the vest to define the two bladder pockets 61 and 63. However, a single large pocket may be provided capable of receiving a structured insert configured to hold the bladders in the orientation, as will be described in greater detail below. Alternatively, hook and loop fastener panels can be used to directly attach the bladders to the garment without the using formed pockets. In the pocket configuration, releasable fasteners, such as hook and loop fasteners, are used on the lateral edges 64 of the bladder pockets 60 allowing easy installation and removal for laundering of the garment or repair or replacement of the inflation bladders. The fasteners are located far lateral to prevent the creation of a pressure points on the patients body.

Additionally, the garment type patient turning and lifting device 12 may include means for restraining the patient in a bed. The vest can be provided with a number of stitched flat loops 66 on the posterior side of the vest, preferably between the bladder pockets, along the center seam 65. The loops are designed to be used with a belt-type restraint system that can be connected to either side of the bed. They are similar to cloth belt loops on a pair of pants. Soft cloth restraints can be passed through the loops, much like a belt loop, that can prevent falling out of the bed yet allow limited mobility in the bed. This type of restraining system is less restrictive to the patient than some conventional belt restraints that join directly to the limbs.

Though not shown in the figures, alternative garment configurations are also possible with the present invention that are useful to turn and reorient other regions of the patient's body that may be immobilized. For example, in addition to relieving pressure on a patient's back (torso 34), the region of the pelvis may also need to be repositioned during the period of immobilization. To accomplish this, the vest 20 may be lengthened to encompass the lower torso and pelvic region 42 of a patient 14. In such a lengthened garment, the inflation bladders 16 also would need to be lengthened to encompass the pelvic region or additional inflation bladders, separate from the inflation bladders serving the torso region could be provided in the garment. Alternatively, pants embodying the invention could be fashioned to hold inflation bladders that could lift the pelvis or legs 44 of a patient. A garment having full-length sleeves accommodating inflation bladders could be provided to lift the arms 32 and socks having attachable inflation bladders could be fashioned for lifting the feet of a patient. By the foregoing, it can be understood that a variety of garments can be fashioned embodying the present invention to accommodate turning and reorienting various regions of the body that may be immobilized. All such variations are considered to be encompassed within the scope of the present invention.

In a preferred embodiment, a vest 20 has two bladders that extend from the top of the shoulder to the top of the buttocks of a patient. Preferably, the left bladder 91 is identical to the right bladder 93, making them interchangeable. The tubing 48 that delivers the pressurized fluid from the pump enters at a port 70 midway from the lateral to the midline side, on top surface 110 of the bladder near the neck of the garment. The tubing 48 is highly flexible and can be molded to the bladder or connected with a simple luer-lock tubing connector common in medical equipment. The bladders can be interchanged from left to right simply by flipping them over. The top becomes the bottom and the bottom becomes the top. The operating pressures encountered during use are calculated to be approximately less than about 1 psi. The maximum pressure of the bladders is approximately at least three times their operating pressure. The tubing is typically made of vinyl for flexibility but can be made of any flexible tubing such as soft rubber. The inside diameter is 3/16^{th} inch but can be varied to accommodate different rates of fill and deflation. The tubes are single coming out of each bladder and are connected to one another on the way to the pump on the floor. They can be connected to each other with plastic connecting clips to keep them out of the way.

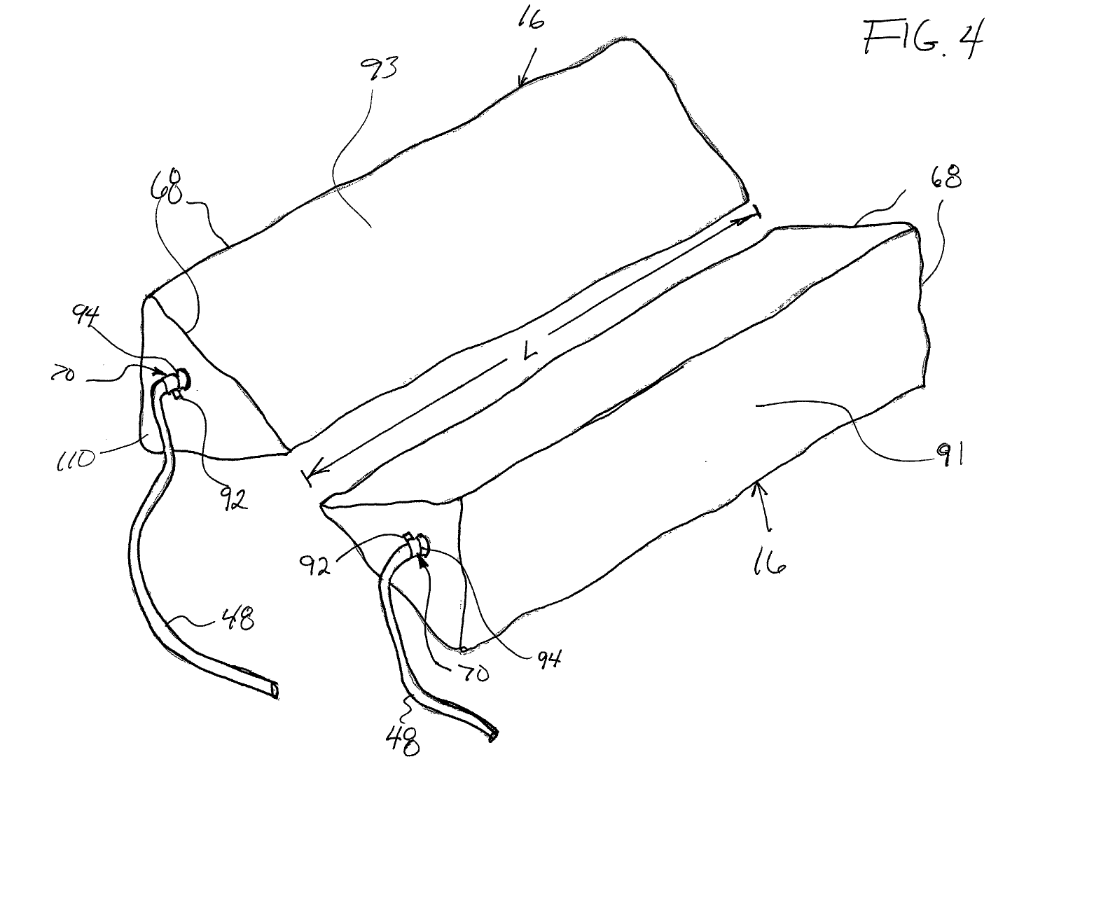

There are several preferred bladder configurations each capable of being attached to the garment by way of fitting into the pockets 60 of the garment. In a first embodiment shown in FIG. 4, the bladders 16 comprise fluid-tight, inelastic but flexible wall independent bladders 91 and 93 formed to mimic the shape of the garment pockets 60. In the case of the vest 20 shown in FIGS. 2 and 3, the pockets, and corresponding bladders are wedge shape, having a triangular cross-section over a given length L, roughly equal to the length of the back of the intended patient. Each bladder 91 and 93 is removable from and securable to the garment by sliding it into the pocket, either through a top opening or an open through lateral edge 64. After placement into the pocket, releasable securement mechanisms, such as strips of hook and loop fasteners may be used to secure the lateral edge or close a flap over the pocket top opening.

The inflation bladders 16, shown in detail in FIG. 4, may be formed from any flexible, durable fluid tight material. PVC is a preferred material for the bladders, but other materials could be used. Rubber and other flexible polymers work equally as well, but PVC is believed to be the most economical and durable and lends itself to simple bladder construction techniques. Furthermore, these materials can be formed as flexible walled bladders that are capable of retaining a definite shape, such as the wedge shape preferred for the vest garment embodiment. The seams 68 of the PVC bladders 16 can be heat, sonically bonded, or chemically bonded. The bladders are extremely flexible when deflated making the vest comfortable in any stage of inflation or deflation. They can be filled with air, liquid, or other gases such as CO₂.

A port 70 is provided on each bladder, regardless of configuration, to provide fluid communication with the interior of the bladder. The port may be formed into or bonded onto a wall 110 of the bladder. The port 70 may comprise a pressure line fitting 94 that permits a fluid tight connection between the pressure lines 48 and interior of the bladder. The pressure line fitting 94 may comprise a simple polymer nipple fitting that is permanently bonded to the pressure line or may be formed as a high density polymer luer-lock type fitting for quick release capability of the pressure lines. In either case, the pressure line fitting should incorporate a quick release valve 92 that can be configured to be easily manipulated by a health care provider to quickly release the pressurized fluid from the system to deflate the bladders. The valve may comprise a simple spring loaded piston valve operated by manually depressing the piston to open the valve for fluid release.

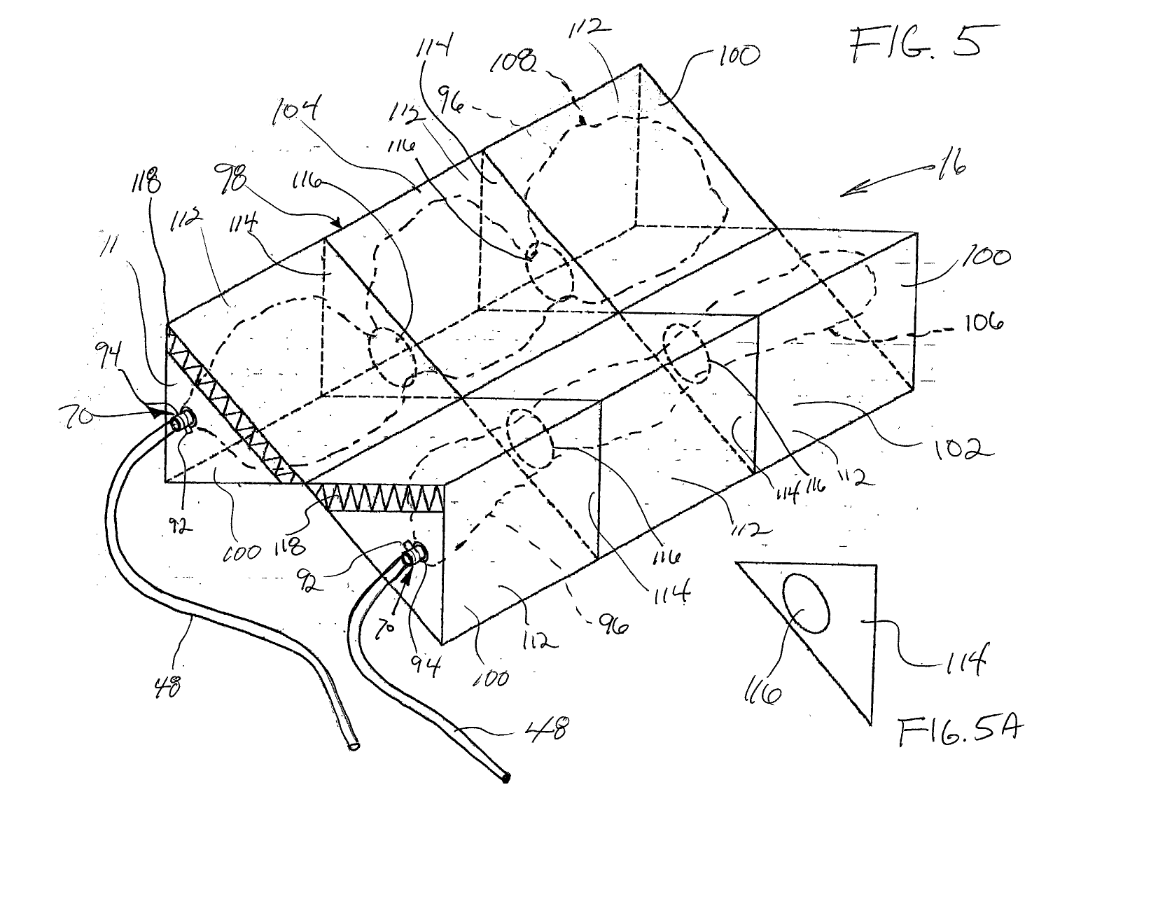

In another preferred embodiment, shown in FIG. 5, the bladders comprise fluid tight, flexible, elastic-walled soft bladders 96 removably contained in a flexible bladder-pack insert 98 having flexible but substantially inelastic walls 100 that define the desired inflated shape. The bladder-pack insert 98 shown in FIG. 5 is configured to cooperate with the vest garment embodiment shown in FIGS. 2 and 3, although other bladder pack configurations could be made to fit garments intended for other regions of the body. For the vest embodiment, the bladder-pack insert is configured to have a left and right housings 102 and 104, respectively, containing left and right soft bladders 106 and 108, respectively. It is noted that the reference to left and right refers to the patient's perspective when wearing the garment.

The apparatus shown in FIG. 5 is presented in an isometric view with the ports 70 oriented on a top surface 110 when worn by a patient as shown in FIG. 3. The insert operates to force the soft bladders to conform into the desired shape when inflated. The structural support offered by the insert 98 permits the use of an inexpensive elastic bladder material that may be preferable for use in a fully disposable device. For purposes of illustration, in FIG. 5, the right soft bladder 108 is shown in a partially inflated condition and the left bladder 106 is shown in a substantially deflated condition. Also for illustration purposes, the bladder-pack insert 98 is shown in fully expanded condition to show the desired resulting shape, although the soft bladders 96 are not fully inflated to cause such an expanded condition. It should be understood that the insert 98 would only be fully expanded if the soft bladders 96 were fully inflated.

As the bladders 96 are inflated with pressurized fluid, they expand to fill the space defined by the chambers 112. Although the bladders 96 may be formed from an elastic material, the inelastic material forming the panels 100 of the bladder-pack insert 98 serve to confine the inflating bladders 96 so that it fills the interior of the insert, expanding it to its fully expanded dimensions. It has been found that dividing the interior of the insert 98 into several smaller chambers 112 through the use of flexible baffles 114 helps to help conform the expanding bladders 96 into the desired shape defined by the insert 98. As shown in FIG. 5, the insert 98 is divided into six separate chambers 112, with three chambers defined along each of the left and right housings 102 and 104, respectively. The baffles 114 and passageways 116 serve to keep the bladders 96 located in position relative to the interior of the insert 98 so that they do not slide around which could permit inadequate expansion of the insert 98. FIG. 5A shows a detail of a baffle wall 114 with a circular passageway 116 through its surface to permit passage of a bladder 96.

A soft bladder 96 may be inserted into the left or right housing 102 or 104 in a deflated condition by sliding the bladder through an opened top panel 111, which is preferably configured as a flap releasably securable along one edge by a simple fastener 118, such as hook and loop fastener. The bladder 96 is then advanced by hand through the several baffles 114 via a circular passageway 116 formed through each baffle 114. A deflated bladder 96 is easily inserted through baffles 114 to extend through all three individual chambers 112 of the left or right housing as is best illustrated by the left bladder 106, deflated and extending through the left housing 102 in FIG. 5. After the bladder is inserted, the top wall 111 may be secured shut prior to operation of the device.

Inflation of the soft bladder 108 in an insert 98 is illustrated in the right housing 104 shown in FIG. 5. The right partially filled soft bladder 108 is restricted to expand in segmented shape corresponding with the three chambers 112 defined by the baffles 114. The bladder 108 remains constricted at passageways 116, but still expands sufficiently in the chambers 112 to fully expand the insert 98 to the desired dimensions.

The insert may be formed from any flexible substantially inelastic materials such as polyester fabric material. However, the insert may also be made from an inexpensive material so that it can be made disposable. A suitable inexpensive material may be a heavyweight paper product. The soft bladders 96 may be formed from polyethylene and may have any shape capable of forming a closed bladder. Though the shapes may vary, the bladders should have sufficient volume to fill all the interior chambers 112 of the insert 98.

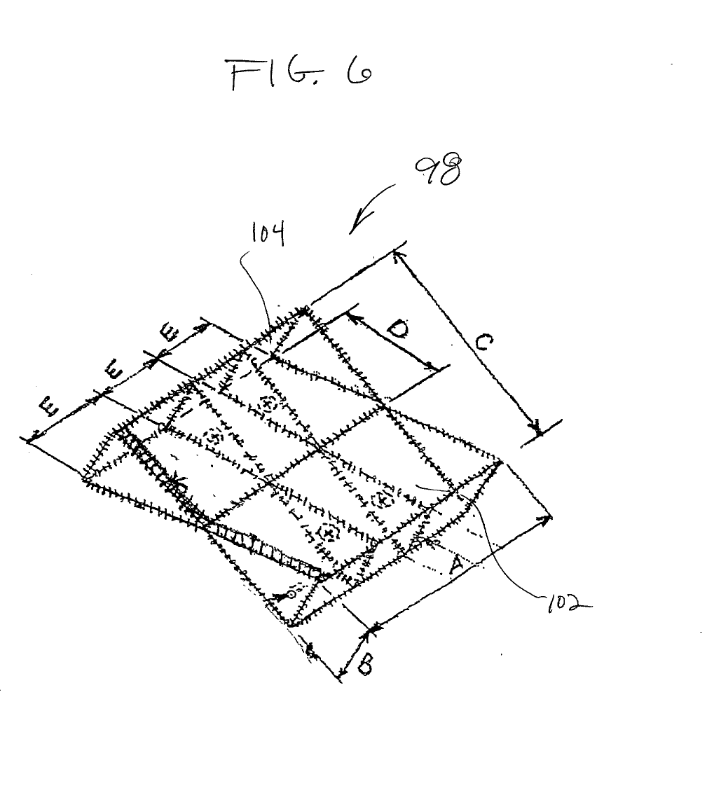

FIG. 6 shows an isometric illustration of a bladder-pack insert 98 shown with several dimensional variables that are defined in the table presented below for a preferred vest garment type of device. The dimensions presented for the insert 98 are also applicable to the dimensions required for a pair of independent bladders 90 configured to be inserted into vest pockets 60, shown in FIG. 4, when the wedge-shaped bladders are placed adjacent each other as they would be arranged inside the pocket. The table below presents dimensions in inches for small, medium and large vest sizes. It is emphasized that these dimensions are merely meant to be illustrative and are not intended to limit the scope of the invention to a particular size range.

| Dimensions shown | Vest Garment Sizes | | |
|---|---|---|---|
| in FIG. 6 | Small | Medium | Large |
| “A” | 22 | 24 | 26 |
| “B” | 4 | 4 | 5 |
| “C” | 14 | 16 | 18 |
| “D” | 7 | 8 | 9 |
| “E” | 6⅝ | 7⅝ | 8 |

To vary the magnitude of elevation, a patient may be lifted from the supporting surface, where dimension B defines the maximum height of the wedge bladder, may be varied. For example, the dimension B shown for a large size garment is shown above as five inches. However, that dimension may be increased to seven or nine inches to provide increased lifting distance when required in particular care giving situations.

Air is the preferred fluid to operate the system because it is economical and the simplest to implement. Pressurized CO₂ may be a desirable fluid medium because it is generally available in most hospitals with plumbed ports available at each bed site. Use of pressurized CO₂ could provide a backup operation strategy, if the air pump becomes inoperative due to power failure or malfunction, or is unavailable. A liquid such as water may also be used to inflate the bladders. Water may be advantageous in certain applications because of the incompressible characteristic of liquids. For example, inflation of the bladder with a liquid may be desirable in order to promote uniform contact pressure against a body region of a patient. However, for most applications, air is preferred because it avoids the complications of moisture interacting with other equipment when water is introduced to the area. Also water can be more cumbersome to supply to the system. However, it is noted that, if the device is to be designed for use with water, the fluid circuit is configured as a closed loop system and a suitable water pump would be used.

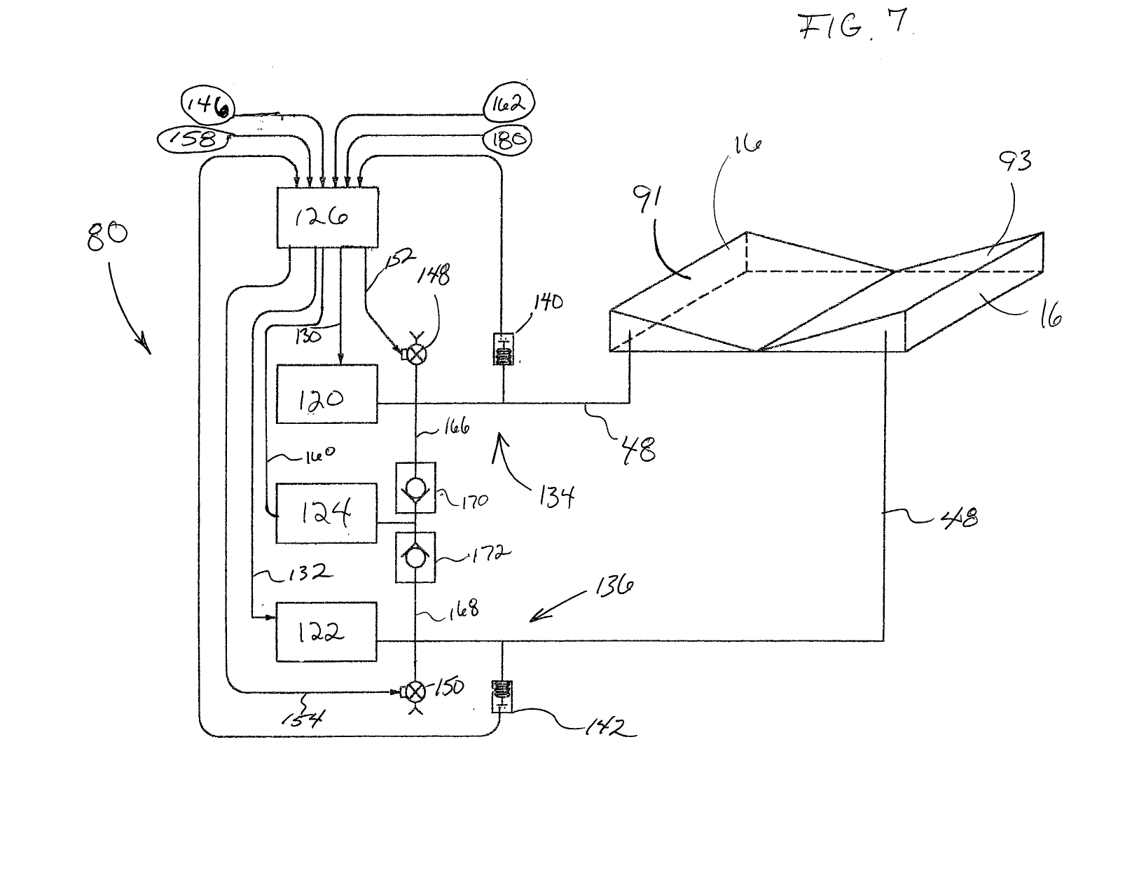

The pump system 80, shown in FIGS. 1 and 7, comprises at least one fluid pump to pressurize fluid to fill the bladders. In a preferred arrangement, using air as the fluid medium, a suitable pump may be an industrial vibrating armature pump, However, the pump may also be a vane pump, linear pump, diaphragm pump, rotary pump or a vane type pump. It should be able to pump up to 3 psi at approximately 5 cubic feet per minute. Preferably the pump is silent when running. Ideally, the power requirements for the pump are 120 volts AC 60 cycles, but can be a low voltage 24 volt, 12 volt, or lower. Alternatively, battery power could be used if needed. The pump can also be a manual type pump similar to a foot pump used to inflate air mattresses.

In a preferred embodiment, the pump system 80 comprises a separate pump for each bladder that is to be inflated plus another separate pump dedicated to the rapid inflation of all bladders for immediate lifting of the patient. FIG. 7 shows a diagrammatic illustration of the fluid circuit for this preferred pump system arrangement. The pump system 80 is shown in fluid communication with left and right independent inflation bladders 91 and 93, respectively.

The pump system 80 comprises a left pump 120, right pump 122, a rapid inflation pump 124 and pump controller unit 126, among other items. Preferably, all components of the pump system 80 are contained in one housing as is shown in FIG. 1, to facilitate mobility of the system and maintain a neat and organized appearance in the patient environment. The left inflation pump 120 is in fluid communication with the left bladder 91 through the pressure line 48 to form a left fluid circuit 134. The left inflation pump is also electrically wired to the controller 126 via connection 130. Through the connection 130, the left inflation pump is energized at the command of the controller unit 126. Also, in fluid communication with the left fluid circuit 134 is a left pressure switch 140 that is also electrically connected to provide pressure data to the controller 126.

The right fluid pump 122 is in direct fluid communication with right independent inflation bladder 93 via a pressure line 48 that is separate from the pressure line in communication with the right bladder 91, thereby forming a right fluid circuit 136. The right inflation pump 122 is also connected to the pump controller 126 via electrical connection line 132. Also in fluid communication with the right pressure circuit 136 is right pressure switch 142. The purpose of pressure switches 140 and 142 is to monitor the pressure in left and right pressure circuits 134 and 136, respectively and transmit the data to the controller 126. When the pressure switch indicates that a preselected bladder pressure has been reached, the controller discontinues power to the fluid pump to stop inflation. Preferably, the controller will display the desired pressure selection as a choice of applicable patient weight ranges. For example, three options may be provided on the controller, for example, 75-100 pounds, 100-200 pounds and 200-300 pounds. The weight range control input is indicated as reference numeral 146 on the pump controller 126.

Also in fluid communication with right and left pressure circuits 134 and 136 are left and right release solenoid valves 148 and 150, respectively. The solenoid valves are electrically actuated and receive electrical input signals from the pump controller via left and right solenoid control lines 152 and 154, respectively. The pump controller 126 signals the solenoid valves 148 and 150 to remain closed to pressurize either or both the left and right bladders 91 and 93 and signals the solenoid valves to open to release pressure from the left or right pressure circuits 134 or 136 in order to deflate the bladders when desired. Deflation of the bladders occurs unassisted. Fluid leaves the fluid circuit through the open solenoid valve expedited only by the weight of the patient on the bladder. Preferably the bladder deflation time (from full pressurization of approximately 1 psi to equilibrium) is regulated to be approximately five minutes. Deflation time can be varied simply by adjusting the orifice size of the air release solenoid. For example, to achieve a deflation time of five minutes with devices sized as discussed above, an orifice size of approximately 1/64″ has been found to be adequate.

Preferably, the pump controller 126 includes a sequencing control 158 that is configured to permit selection of inflation duration and sequence of inflation of the bladders. For example, the control setting 158 will preferably enable one to control how long a bladder remains in the inflated condition and will also permit the user to inflate both bladders, deflate both bladders or initiate inflation of one bladder while the other is deflating in order to maintain the patient's body supported away from the patient supporting surface. The bladders can be sequenced allowing one to fill and one to remain empty for a determined period of time. The filled bladder can then be deflated and the unfilled bladder can be inflated. Both bladders can also be deflated for a previously determined amount of time before repeating the process to allow time in the supine position. They can also be adjusted to avoid certain positions. For example, the controller could be set to inflate the right bladder while the left bladder deflates and vice versa, avoiding the supine position for a predetermined amount of time.

In addition to fluid pumps 120 and 122, in the preferred embodiment, a third quick-inflate pump 124 is provided for the purpose of rapidly inflating all inflation bladders to lift the patient from the patient supporting surface. The quick lift feature facilitates administration of routine patient care such as toileting and bathing, etc . . . . Rapid inflation time to fill the bladders is on the order of about 15 seconds. The quick inflate pump 124 is electrically wired to the pump controller 126 via line 160. The quick inflate pump 124 can be actuated at any time by the user by operation switch 162 on the pump controller 126. The quick inflate pump 124 will immediately operate to inflate all bladders in the fluid pressure circuit. As shown in FIG. 7, the quick inflate pump 124 is in fluid communication with the left and right fluid circuits 134 and 136, respectively via fluid lines 166 and 168. Check valves 170 and 172 are installed in pressure lines 166 and 168 to insure unidirectional flow only outward from the quick-inflate pump. The check valves 170 and 172 insure that pressure will not be released through the quick inflate pump connections, but permit the quick inflate pump to pressurize the left and right fluid circuits 134 and 136 at any time during operation of the pump system 80. After use of the quick inflate pump, the pump system can be returned to normal operation by releasing the pressure fluid circuits 134 and 136 through the solenoid valves 148 and 150 so that bladders 91 and 93 are once again inflated by left and right fluid pumps 120 and 122.

The bladders can be filled to predetermined capacities to yield predetermined pressures for either a soft or a firm surface. This adjustment is made on the controller 126. The pump system 80 can be energized via an electrical connection 180 to an available 110 volt current or may be configured to run from batteries if a power source is unavailable. Optionally, the functions of the pump controller may be manipulated remotely, either by a remote control hard wired to the controller 126 or by a wireless remote control unit using technology such as infra red to send commands to a base unit at the controller 126. Remote control may facilitate operation of the device by an immobilized patient.

As an alternative to the automated pump system described above, the patient turning and lifting device can be operated with a manually operated pump. If a manual pump is used, the bladder of choice is filled by operating a foot pump or hand pump until the bladder is inflated to the desired pressure. A transfer valve (not shown) in fluid communication between the bladders is then manually adjusted to deflate this bladder and simultaneously inflate the other bladder by the same process. This system would not be automatic and requires a caregiver to operate, but the cost is substantially less for a device that is still capable of lifting and turning an immobilized patient from right to left and supine positions and any variation in between.

It should be understood that the foregoing description of the invention is intended merely to be illustrative thereof and that other modifications, embodiments and equivalents may be apparent to those skilled in the art without departing from its spirit.

1. A portable patient turning and lifting device comprising:
at least one inflation bladder having a fluid port and being configured to be securely positioned between a body of a patient and a patient supporting surface.

2. A patient turning and lifting device as defined in claim 1 further comprising a garment configured to be worn by the patient and configured to releasably secure the portable inflation bladder between the patient's body and the patient supporting surface.

3. A patient turning and lifting device as defined in claim 2 wherein the inflation bladder is releasably secured to the garment by containment within a pocket of the garment that orients the bladder between the patient supporting surface and the patient's body.

4. A patient turning and lifting device as defined in claim 1 further comprising securing means on the inflation bladder for releasably securing the bladder to the patient supporting surface.

5. A patient turning and lifting device as defined in claim 4 further comprising:
left and right inflation bladders securable to a patient supporting surface and positioned to correspond to left and right portions of a patient's torso region when lying on the patient supporting surface.

6. A patient turning and lifting device as defined in claim 4 wherein the securing means comprise hook and loop fasteners.

7. A patient turning and lifting device as defined in claim 1 further comprising:
at least one fluid pump in fluid communication with the inflation bladder.

8. A patient turning and lifting device as defined in claim 7 wherein the fluid pump is electrically operated and further comprises a controller to provide user control of inflation variables.

9. A patient turning and lifting device as defined in claim 1 further comprising:
a manually operated fluid pump in fluid communication with the inflation bladder.

10. A method of turning and lifting an immobilized patient comprising:
providing at least one inflation bladder;
securing the inflation bladder between the patient's body and a patient supporting surface;
inflating the bladder with a fluid to move at least a portion of the patient's body away from the patient supporting surface.

11. A method of turning and lifting an immobilized patient as defined in claim 10 further comprising:
providing a garment configured to carry at least one inflation bladder,
and securing the garment to the patient before inflating the bladder.

12. A method of turning and lifting an immobilized patient as defined in claim 10 further comprising:
providing securing means on the inflation bladder and securing the inflation bladder to the patient supporting surface before inflating the bladder.

13. A method of turning and lifting an immobilized patient as defined in claim 10 further comprising:
providing a fluid pump system in fluid communication with the inflation bladder comprising:
at least one fluid pump;
a pump controller configured to control variables of inflation; and
adjusting the controller to a desired bladder inflation operation.

14. A method of turning a patient as defined in claim 10 further comprising:
providing a manual fluid pump in fluid communication with the inflation bladder and
operating the manual fluid pump to inflate the inflation bladder.

15. A patient turning and lifting device comprising:
a garment configured to be worn about at least a portion of the body of a patient and having a front, a back, a left side and a right side,
inflation bladders arranged at least on left and right sides of the back of the garment,
each bladder having a port in fluid communication with the bladder.

16. A patient turning and lifting device as defined in claim 15 further comprising:
at least one pocket on the garment configured to releasably receive the inflation bladders.

17. A patient turning and lifting device as defined in claim 16 wherein the inflation bladders further comprise flexible, substantially inelastic walls configured to form wedge-shaped bladders sized to fit within the pocket of the garment.

18. A patient turning and lifting device as defined in claim 16 further comprising:
a bladder pack insert having flexible inelastic walls and forming at least one interior chamber,
at least one inflatable bladder configured to fit in the bladder pack, and the bladder pack being configured to fit within a pocket of the garment.

19. A patient turning and lifting device as defined in claim 15 wherein the garment is configured as a vest with a securable opening to permit donning by the patient and configured to fit about the torso of the patient.

20. A patient turning and lifting device as defined in claim 17 further comprising releasable securement mechanism at the opening for maintaining the vest closed to secure it about the torso of the patient.

21. A patient turning and lifting device as defined in claim 15 further comprising at least one restraint connection point for securing the garment to a patient's bed.

22. A patient turning and lifting device as defined in claim 15 wherein the garment is formed from a durable fabric suitable for repeated use and laundering.

23. A patient turning and lifting device as defined in claim 15 wherein the garment is formed from a light-weight material suitable for disposability.

24. A patient turning and lifting device as defined in claim 15 further comprising a pump system in fluid communication with the bladders.

25. A method of turning a patient comprising:
providing a garment having left and right inflation bladders,
securing the garment about at least a portion of a patient's body so that the left and right inflation bladders coincide with left and right sides of the patient's torso,
orienting the patient on a supporting surface with the inflation bladders situated between the surface and the patient's torso,
alternatively inflating the inflation bladders to move the body of the patient from the supporting surface.

26. A method of turning a patient as defined in claim 25 further comprising:
providing a fluid pump system comprising and a pump controller and at least one fluid pump;
setting the controller to operate the pump to inflate the bladders in a desired sequence.

27. A method of turning a patient as defined in claim 26 wherein the pump controller is set to inflate the left and right bladders in an alternating sequence to move the left and right sides of the patient away from the supporting surface in an alternating fashion.

28. A method as defined in claim 25 further comprising:
providing a manual fluid pump in fluid communication with the inflation bladders and operating the manual fluid pump to inflate at least one bladder to move the body of the patient.

29. A method of turning a patient as defined in claim 25 further comprising:
securing the garment to a patient restraint system secured to a patient's bed.

30. A system for lifting an immobilized patient comprising:
a garment configured to be worn about a torso region of a patient's body and being configured to hold at least one inflation bladder;
a fluid pump system comprising at least one fluid pump and a controller for controlling the operation of the pump to regulate the variables of sequence of inflation and inflation time, the pump in fluid communication with the inflation bladder to create a fluid circuit;
a release valve in fluid communication with the fluid circuit for releasing fluid from the fluid circuit; and
a releasable fastener for securing the garment on the body of a patient.

31. A system as defined in claim 30 further comprising a quick-inflation fluid pump in fluid communication with the fluid circuit.

32. A system as defined in claim 30 wherein the garment is configured as a vest having a left side and a right side and a back side and being configured to a left and right inflation bladder on the backside of the vest.

33. A system as defined in claim 30 wherein a separate pump and fluid circuit is provided for each inflation bladder provided.

34. A system as defined in claim 32 wherein left and right fluid pumps and left and right fluid circuits are in fluid communication with the left and right inflation bladders.

35. A system as defined in claim 32 further comprising a pillow releasably securable to the vest and arranged to support a patient's head.

36. A system as defined in claim 32 further comprising a remote control unit for operating the functions of the controller.
